(19) United States
(12) Patent Application Publication
(10) Pub. No.: US 2016/0261801 A1
(43) Pub. Date: Sep. 8, 2016

(54) IMAGE CAPTURING APPARATUS AND CONTROL METHOD FOR THE SAME

(71) Applicant: CANON KABUSHIKI KAISHA, Tokyo (JP)

(72) Inventor: Yohei Horikawa, Tokyo (JP)

(21) Appl. No.: 15/059,595

(22) Filed: Mar. 3, 2016

(30) Foreign Application Priority Data
Mar. 4, 2015 (JP) 2015-042974

(51) Int. Cl. H04N 5/232

(52) U.S. Cl. CPC H04N 5/23287; H04N 5/23212

(57) ABSTRACT

An image capturing apparatus comprising: an image sensor that includes a plurality of photoelectric conversion portions that correspond to each of a plurality of microlenses, and performs photoelectric conversion on a light flux that enters via an image stabilization optical system; a refocus unit that performs refocus processing based on output from the image sensor; and a determination unit configured to, based on a shake signal, determine a drive amount of the image stabilization optical system, within a range in which variation in defocus amounts at positions of the image sensor, which occurs due to the image stabilization optical system being driven, falls within a range in which a defocus amount is movable by the refocus unit.

### BACKGROUND OF THE INVENTION

1. Field of the Invention

The present invention relates to an image capturing apparatus and a control method for the same, and in particular relates to an image capturing apparatus having a shake correction function and a refocus function, and a control method for the same.

2. Description of the Related Art

Conventionally, a digital camera having a shake correction function has been proposed. With a digital camera having a shake correction function, the shake correction function is realized by changing the attitude of an optical member and/or an image sensor in a desired direction according to a detected shake amount. With the method of changing the attitude of an optical member, it is possible to widen the angle in which correction is possible by changing multiple optical members in respective independent directions.

Japanese Patent Laid-Open No. 2009-258389 discloses a method in which a frontward first movable lens barrel that supports a first optical member and a rearward second movable lens barrel that supports a second optical member are arranged with a fixing member interposed therebetween, and thereby the movable lens barrels are driven independently of each other so as to correct shake. Also, Japanese Patent No. 3003370 discloses a method of correcting shake by driving an optical member such that an arc is traced with a point on an optical axis serving as the center of rotation.

On the other hand, by arranging a microlens array with a ratio of one microlens for a plurality of pixels on a front surface of an image sensor, it is possible to acquire not only a two-dimensional intensity distribution of light, but also information on the entrance direction of light rays that enter the image sensor, and to obtain three-dimensional information on the subject space. A camera capable of obtaining this kind of three-dimensional information on the subject space is called a light-field camera. Moreover, the three-dimensional information on the subject space is called light-field data, and by acquiring the light-field data and performing image reconstruction after shooting, it is possible to perform image processing known as refocusing, such as changing the focus position of the image, changing the shooting viewpoint, and adjusting the depth of field.

With this kind of light-field camera, a plenoptic method is widely known. With the plenoptic method, divided photoelectric conversion elements (PD) for image capture are arranged two-dimensionally below microlenses in a microlens array, and focus lenses included in an optical system serve as exit pupils for the microlenses. In an image capturing apparatus with this kind of configuration, it is known that signals obtained from multiple PDs existing below the microlenses include multiple pieces of light ray information from the subject. Multiple two-dimensional images, which are each formed using, among the signals obtained from the group of PDs located below the microlenses, only signals obtained from PDs that exist at the same location with respect to each microlens using the light ray information, have parallax with respect to each other, unlike normal two-dimensional images. By compositing the two-dimensional images with such parallax, it is possible to virtually move the focus plane of the image (see Japanese Patent Laid-Open No. 2009-258610).

Moreover, International Publication No. 2008/050904 discloses a technique of performing deformation such that certain regions of the parallax images overlap and adding the parallax images together so as to reconstruct an image and thereby set a virtual focus plane in a depth-wise oblique direction in a light-field camera.

However, if a group of lenses are driven such that an arc is traced with a point on an optical axis serving as the center of rotation, as described in Japanese Patent No. 3003370, in order to perform blur correction, a slope appears in the image plane, whereby blurring in accordance with the image height (uneven blurring) appears in the image sensor that forms the image. If this kind of uneven blurring occurs in each frame while shooting a moving image, a problem occurs in that the quality of the shot moving image is significantly reduced.

With regard to this problem, in the case of correcting uneven blurring using the refocusing technique disclosed in International Publication No. 2008/050904, a refocus limit exists, and therefore there is a problem in that correction cannot be performed without restriction.

### SUMMARY OF THE INVENTION

The present invention has been made in consideration of the above situation, and uses refocus processing to accurately correct uneven blurring that appears accompanying shake correction.

According to the present invention, provided is an image capturing apparatus comprising: an image sensor that includes a plurality of photoelectric conversion portions that correspond to each of a plurality of microlenses, and is configured to perform photoelectric conversion on a light flux that enters via an imaging optical system including an image stabilization optical system; a refocus unit configured to perform refocus processing based on output from the image sensor; and a determination unit configured to, based on a shake signal from a shake detection unit, determine a drive amount of the image stabilization optical system for correcting the shake, within a range in which variation in defocus amounts at positions of the image sensor, which occurs due to the image stabilization optical system being driven, falls within a range in which a defocus amount is movable by the refocus unit, wherein the image stabilization optical system is driven based on the set drive amount.

Further, according to the present invention, provided is a control method for an image capturing apparatus comprising an image sensor that includes a plurality of photoelectric conversion portions that correspond to each of a plurality of microlenses, and is configured to perform photoelectric conversion on a light flux that enters via an imaging optical system including an image stabilization optical system, and a refocus unit configured to perform refocus processing based on output from the image sensor, the control method comprising: determining, based on a shake signal, a drive amount for the image stabilization optical system for correcting the shake, within a range in which variation in defocus amounts at positions of the image sensor, which occurs due to the image stabilization optical system being driven, falls within a range in which a defocus amount is movable by the refocus unit; and driving the image stabilization optical system based on the determined drive amount.

Furthermore, according to the present invention, provided is a computer-readable storage medium storing a program for causing a computer for an image capturing apparatus, comprising an image sensor that includes a plurality of photoelectric conversion portions that correspond to each of a plurality of microlenses, and is configured to perform photoelectric conversion on a light flux that enters via an imaging optical system including an image stabilization optical system, and a refocus unit configured to perform refocus processing based on output from the image sensor, to execute the steps of the control method comprising: determining, based on a shake signal, a drive amount for the image stabilization optical system for correcting the shake, within a range in which variation in defocus amounts at positions of the image sensor, which occurs due to the image stabilization optical system being driven, falls within a range in which a defocus amount is movable by the refocus unit; and driving the image stabilization optical system based on the determined drive amount.

Further features of the present invention will become apparent from the following description of exemplary embodiments with reference to the attached drawings.

### BRIEF DESCRIPTION OF THE DRAWINGS

The accompanying drawings, which are incorporated in and constitute a part of the specification, illustrate embodiments of the invention, and together with the description, serve to explain the principles of the invention.

FIG. 1 is a block diagram showing an overall configuration of an image capturing apparatus according to the present invention;

FIGS. 2A to 2C are diagrams showing a configuration of pixel unit cells of an image sensor used in a first embodiment, and examples of obtained images;

FIGS. 3A to 3C are diagrams showing a positional relationship between a first correction lens, a second correction lens, and an image sensor;

FIG. 4 is a diagram illustrating a range in which refocusing is possible in the case of dividing each pixel unit cell into 6×6 sections;

FIG. 5 is a diagram showing change in the focus position by means of driving the first correction lens;

FIG. 6 is a diagram showing a difference between de-focus amounts that occurs due to driving the first correction lens;

FIG. 7 is a flowchart showing driving control operation of an image stabilization optical system according to the first embodiment;

FIGS. 8A to 8C are diagrams showing defocus amounts that occur due to driving the first correction lens and the second correction lens; and

FIGS. 9A and 9B are diagrams illustrating ranges in which refocusing is possible, which are determined according to pixel addition.

### DESCRIPTION OF THE EMBODIMENTS

Exemplary embodiments of the present invention will be described in detail in accordance with the accompanying drawings.

### First Embodiment

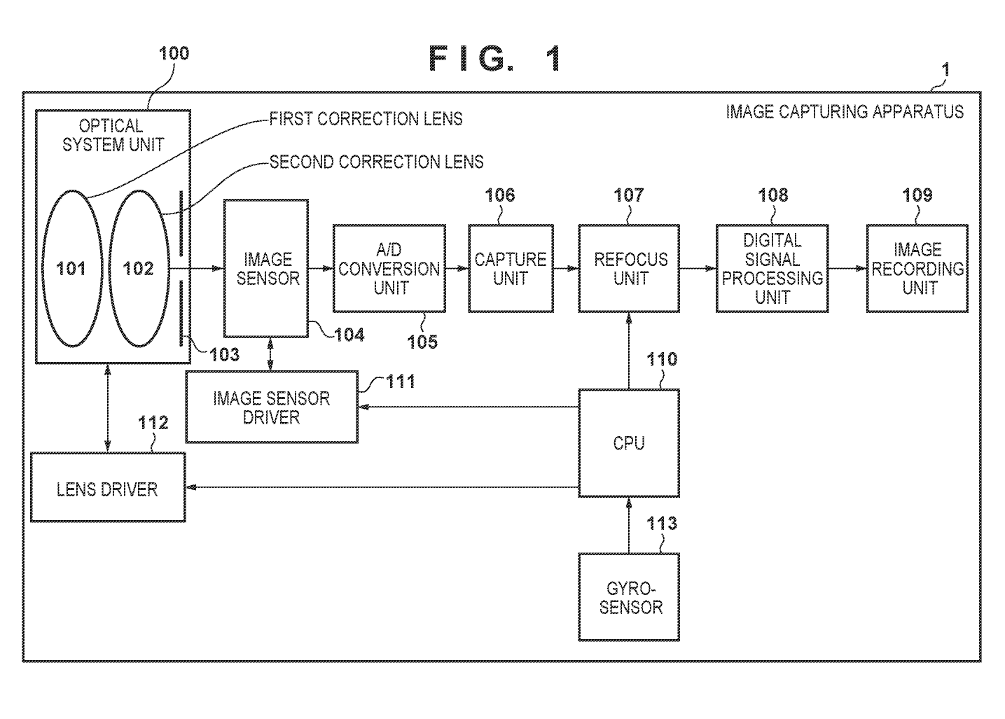

FIG. 1 is a block diagram showing a configuration of an image capturing apparatus 1 according to a first embodiment of the present invention. In FIG. 1, an optical system unit 100 includes at least an image stabilization optical system composed of a first correction lens 101 and a second correction lens 102, and a diaphragm 103. Furthermore, the optical system unit 100 has a zoom lens and a focus lens (not shown), which are driven based on output from a lens driver 112 and configure an image capture optical system together with the first correction lens 101, the second correction lens 102, and the diaphragm 103.

In this first embodiment, the first correction lens 101 is tilted with respect to a vertical plane so that an arc is traced with a point on an optical axis serving as the center, and thus it is possible to refract a light beam that has entered. On the other hand, the second correction lens 102 can translate the light flux that has entered by moving (shifting) in a direction orthogonal to the optical axis.

A gyrosensor 113 detects acceleration in three directions of the image capturing apparatus 1 and outputs it to a CPU 110. The lens driver 112 performs image stabilization driving of the optical system unit 100 in accordance with the output from the CPU 110, and performs control of the tilt angle of the first correction lens 101 and control of the vertical movement amount of the second correction lens 102. Note that the specific control of the tilt angle will be described in detail later.

Moreover, the CPU 110 controls the exposure amount by controlling the diaphragm 103 and a shutter (not shown) that are included in the optical system unit 100 via the lens driver 112. A light flux that enters via the optical system unit 100 is formed on a light reception surface of the image sensor 104 and is subjected to photoelectric conversion. The image sensor 104 is such that pixel unit cells that each include one microlens and multiple photodiodes (PDs), which are photoelectric conversion portions, are aligned in the form of a two-dimensional matrix. Charges accumulated in the PDs are read out with addition or non-addition in accordance with the output from an image sensor driver 111, and are output to an A/D conversion unit 105. The image sensor driver 111 is controlled by the CPU 110, and sets the ISO sensitivity and the like, in addition to switching between addition and non-addition readout of the image sensor 104.

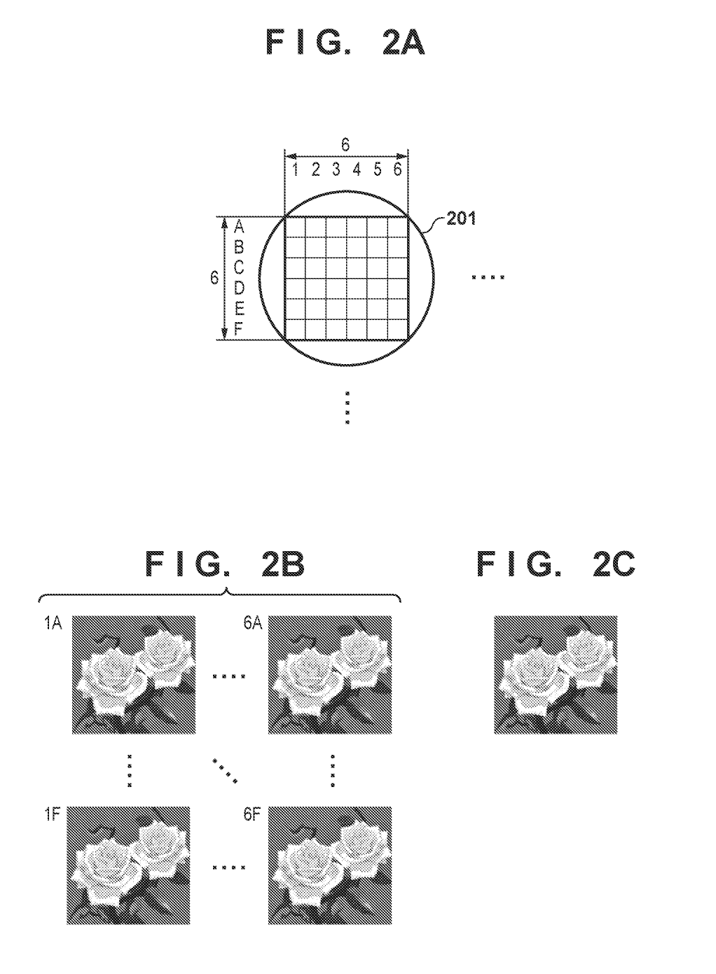

Here, a pixel unit cell arranged in the image sensor 104 in the first embodiment will be described with reference to FIGS. 2A to 2C. As shown in FIG. 2A, a pixel unit cell includes 6×6 PDs 1A to 6F with respect to one microlens 201 included in the microlens array. These kinds of pixel unit cells are arranged two-dimensionally in a Bayer arrangement on the image sensor 104.

After an analog signal processing unit (not shown) performs analog signal processing on analog electrical signals output from the image sensor 104, the A/D conversion unit 105 converts the analog electrical signals into digital electrical signals (pixel signals), which are then output to a capture unit 106. Note that the analog signal processing unit is a CDS circuit, a non-linear amplifier circuit, or the like that removes noise on a transmission path, for example.

The capture unit 106 determines the validity period and type of the pixel signal and outputs signals read out from the PDs 1A to 6F, or signals obtained by performing addition readout from the PDs 1A to 6F to a refocus unit 107 as light field (LF) data.

The refocus unit 107 performs refocus processing in accordance with the PD division number set by the CPU 110 and corrects blurring that appears due to the driving of the first correction lens 101.

In a digital signal processing unit 108, image signals that are input in a Bayer arrangement are subjected to digital signal processing, known representative examples of which include synchronization processing, gamma processing, and noise reduction processing. The output from the digital signal processing unit 108 is recorded in an image recording unit 109 constituted by a memory card such as an SD card, or the like, and is output to an image display unit (not shown).

The CPU 110 is a central processing unit that performs overall system control of the image capturing apparatus 1, and performs operations based on a program recorded in a ROM (not shown). In this first embodiment, the CPU 110 calculates and sets parameters for image stabilization and image correction with respect to the refocus unit 107, the image sensor driver 111, and the lens driver 112.

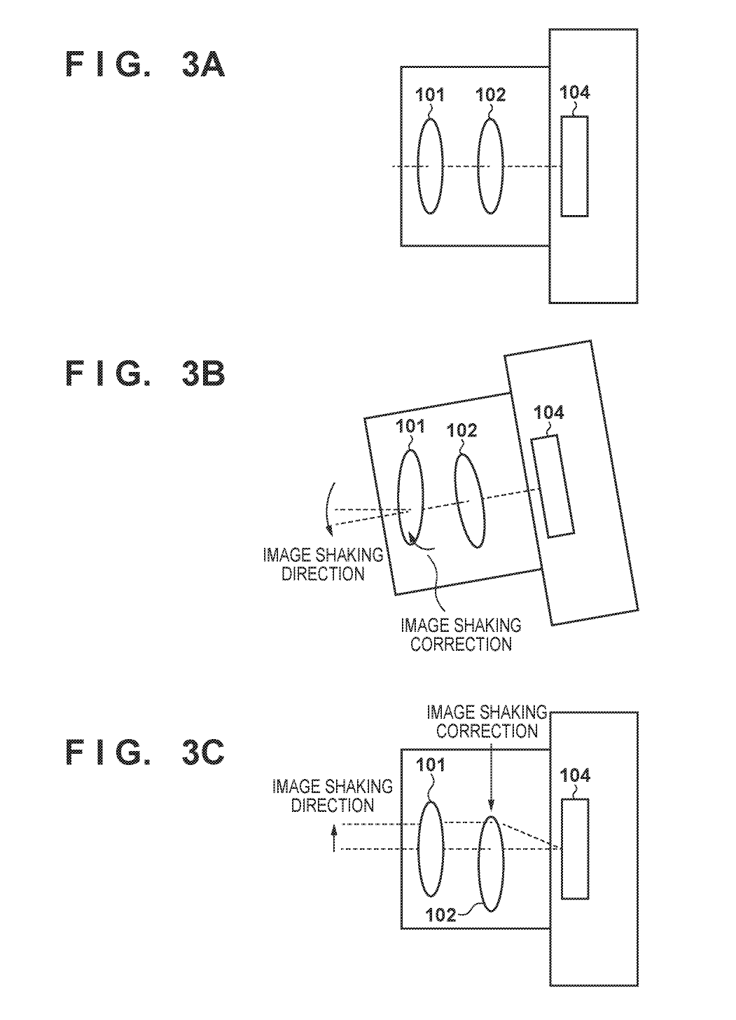

Next, a control method for the first correction lens 101 and the second correction lens 102 in image stabilization control will be described with reference to FIGS. 3A to 3C.

FIGS. 3A to 3C are conceptual diagrams showing an operation of the first correction lens 101 and the second correction lens 102 during an image stabilization operation, and show attitudes of the first correction lens 101, the second correction lens 102, and the image sensor 104. During an image stabilization operation, control is performed such that image blurring is minimized by effectively applying correction lenses with different ways of moving in accordance with whether the zoom lens included in the optical system unit 100 is on a telephoto side or on a wide-angle side.

FIG. 3A shows a state in which there is no image blurring, and the lens centers of the first correction lens 101 and the second correction lens 102 are located on the optical axis.

Next, a state during an image stabilization operation will be described. If the zoom lens is located on the wide-angle side, image blurring is mainly caused by shifting of the camera. Thus, the second correction lens 102 is controlled such that image shifting with respect to the optical axis that occurs due to shifting of the camera as shown in FIG. 3C is counteracted, whereby the image blurring is corrected.

On the other hand, in the case where the zoom lens is located on the telephoto side, image blurring is mainly caused by camera tilting. Therefore, as shown in FIG. 3B, the first correction lens 101 is controlled such that image shifting with respect to the optical axis that occurs due to camera tilting is counteracted, whereby the image blurring is corrected.

It is possible to perform image stabilization by driving the first correction lens 101 and the second correction lens 102 in this way. Note that in the examples shown in FIGS. 3A to 3C, a case was described in which only one of the first correction lens 101 and the second correction lens 102 was controlled, but it is possible to control the first correction lens 101 and the second correction lens 102 in combination with each other.

Next, a range in which refocusing is possible in the case of generating a refocus image using signals obtained from the image sensor 104 having the configuration shown in FIG. 2A will be described.

In pixel unit cells included in the image sensor 104, a two-dimensional image constituted by only signals from PDs existing at the same location with respect to each microlens has parallax with respect to a two-dimensional image constituted by only signals from PDs existing at another location that is the same with respect to each microlens. For example, an image constituted by only signals from PD 1A in FIG. 2A and an image constituted by only signals from PD 2A are different with respect to parallax. That is to say, it is possible to obtain a total of 36 different parallax images from the image sensor 104, which is constituted by 6×6 PDs.

Generally, with a light-field camera, pixels with different parallax corresponding to the number of divided pixels are composited to obtain a refocus image. As a principle for obtaining a refocus image, in the example of the image in FIG. 2B, in the case of compositing such that there is no parallax at the position of the flower, an image that is in focus at the position of the flower and blurred due to adding together and compositing images with parallax at the position of the leaves is obtained. Moreover, in the case of compositing such that there is no parallax at the position of the leaves, an image that is in focus at the position of leaves and blurred at the position of the flower is obtained.

At this time, the range in which refocusing is possible is only the in-focus range of the parallax images. This is due to the fact that even if addition is performed so that there is no parallax in the blurred parallax images, the original image is not sharp, and therefore only a blurred image can be obtained. In other words, the range in which refocusing is possible is determined based on the depth of focus of the parallax images constituted by signals from the PDs at each position.

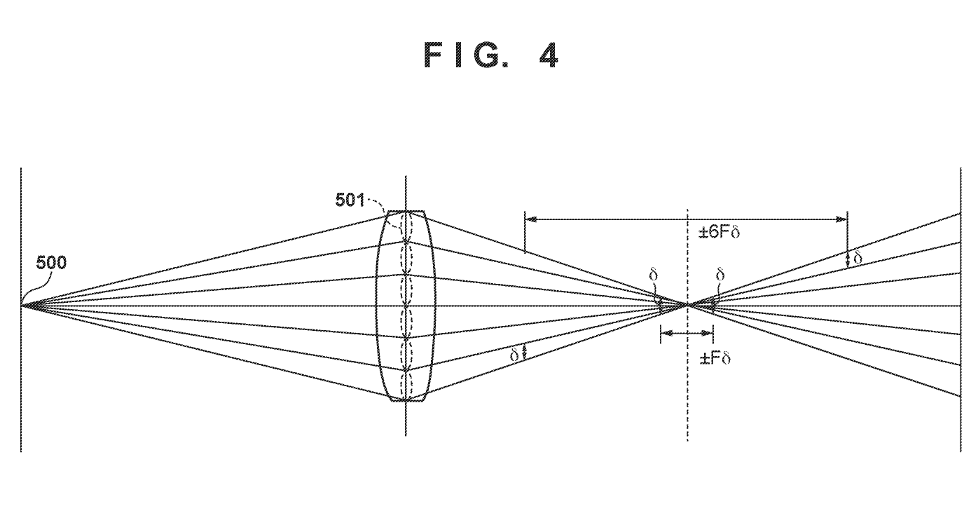

The range in which refocusing is possible will be described in detail with reference to FIG. 4. In FIG. 4, letting δ be the acceptable circle of confusion, and letting F be the aperture value of the diaphragm 103, the depth of field at aperture value F is ±Fδ. In contrast to this, the effective aperture value F01 in the horizontal and vertical direction of a pupil portion region 501 that is smaller due to being divided into 6×6 portions as shown in FIG. 2A becomes darker such that F01=6F (6 is the number of divisions) is satisfied. As a result, the effective depths of field of the parallax images become six times deeper such that ±6Fδ is satisfied, and the in-focus ranges thereof become six times wider. In other words, for each parallax image, an in-focus subject image can be obtained in a range of ±6Fδ for the effective depth of field. A refocus image in a light field is an image obtained by compositing pixels, and therefore it is necessary that the images constituted by the pixels are at least in focus. Thus, with refocus processing after shooting, the defocus amount d can be virtually moved in the range expressed by equation (1).

|d|≦6Fδ (1)

Note that the acceptable circle of confusion δ is defined by the inverse of the Nyquist frequency ½ ΔX (ΔX being the pixel period), or in other words, δ=2 Δx, or the like. Thus, the depths of focus of the parallax images are determined according to the number of divided pixels that share an exit pupil.

Next, blurring that occurs due to driving of the first correction lens 101 will be described with reference to FIG. 5. FIG. 5 is a diagram for describing the Scheimpflug rule, in which points A and B in a subject plane are formed on points A′ and B′ on the image sensor 104 via the first correction lens 101. At this time, it is known that the image plane, main lens plane, and subject plane intersect at a point S. That is, when an image stabilization operation is performed with a tilt operation of the first correction lens 101, the focus plane at the image height center and the focus plane of the peripheral portion of the image sensor 104 are different, and sometimes so-called uneven blurring occurs, where the image is in focus at the image height center but is not in focus at the peripheral portion.

The refocus unit 107 can perform projective transformation on this kind of blurring such that the subject regions at the image height center match in the parallax images, whereby the focus plane can be set in the depth-wise oblique direction. By performing refocus processing on a parallax image input in this way, uneven blurring in the depth-wise oblique direction that occurs due to the driving of the first correction lens 101 is corrected, and the image data resulting from the correction is output to the digital signal processing unit 108. Note that the technique for performing refocusing in the depth-wise oblique direction is known, and for example, it is possible to use the method described in International Publication No. 2008/050904.

Note that refocusing may be performed such that the virtual focus plane is moved to a focus plane in the depth-wise oblique direction based on the tilt angle of the first correction lens 101 that is controlled by the lens driver 112 via the CPU 110.

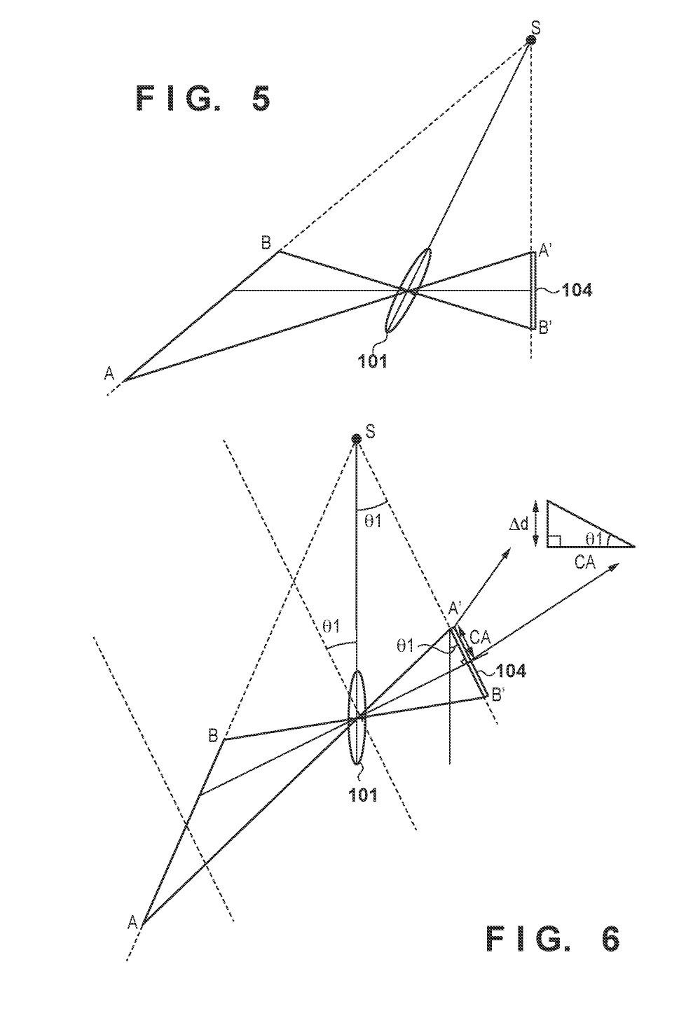

Next, a correction limit at a time of performing processing for correcting uneven blurring by means of refocusing will be described with reference to FIG. 6. FIG. 6 is a diagram illustrating a defocus amount of the image height outermost portion with respect to the image height center in a state in which the first correction lens 101 is not parallel to the image sensor 104. Points A, B, A′, B′, and S are the same as in FIG. 5, CA is the distance from the image height center to the edge portion A′ of the image sensor 104, 01 is the tilt angle of the first correction lens 101, and Ad is a defocus amount difference value indicating a difference between defocus amounts at the image height center and point A′. The defocus amount difference value Ad can be expressed by equation (2) below.

Δd=CA×tan θ1 (2)

If the defocus amount difference value Ad satisfies the condition of equation (3), it is conceivable that correction is possible using refocus processing.

6Fδ≧Δd (3)

Next, a driving limit angle (drive amount limit value) of the first correction lens 101 of the lens driver 112 according to the first embodiment will be described. If there is a change in the readout method of the image sensor 104, the lens driver 112 sets the driving limit angle of the first correction lens 101 through the CPU 110. The driving limit angle is an angle that is determined according to the correction limit for when correcting uneven blurring using the refocus processing, and can be obtained with equation (4) below by solving equation (2) and equation (3) for θ1.

θ1≦tan⁻¹(6Fδ/CA) (4)

Note that when performing crop readout from the image sensor 104, by letting CA be the distance to the position of the edge portion on the image sensor 104 from which crop readout is performed, it is possible to make the driving limit angle larger than in the case of always letting the edge portion in the image sensor 104 be CA.

During an image stabilization operation, the lens driver 112 sets the shift amount of the first correction lens 101 and the tilt angle of the second correction lens 102 based on the output from the gyrosensor 113 via the CPU 110. Note that since a known technique can be used in setting the shift amount and the tilt angle using the gyrosensor 113, description thereof will not be included here.

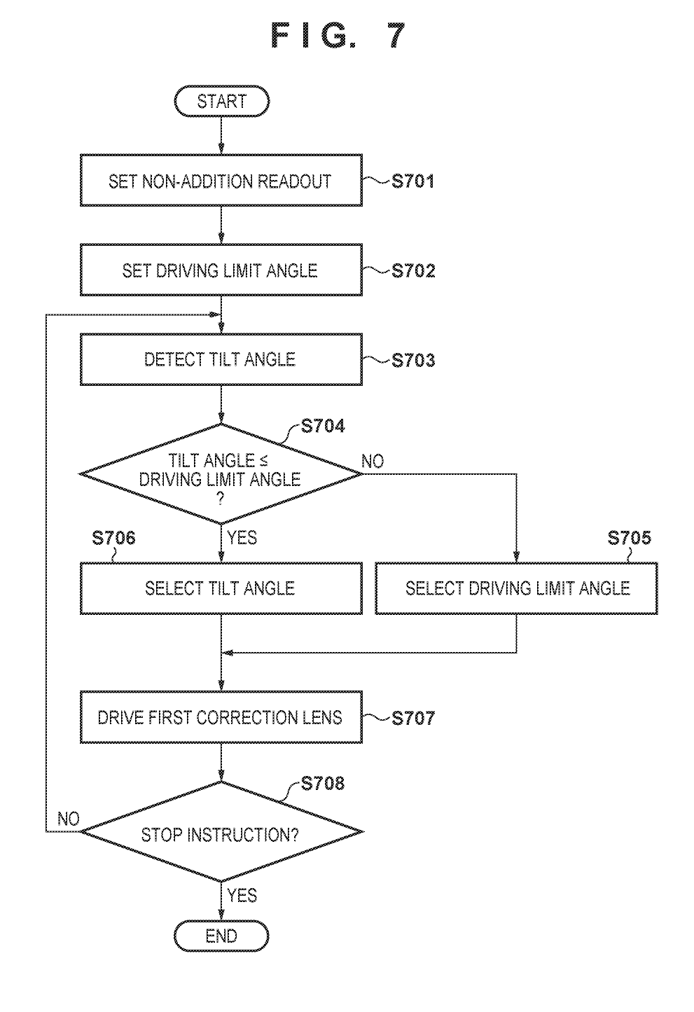

Next, an image stabilization operation according to the first embodiment will be described with reference to the flowchart shown in FIG. 7. This image stabilization operation is started by a user operating moving image shooting SW (not shown).

In step S701, the CPU 110 sets non-addition readout of the PDs 1A to 6F in the image sensor driver 111. In step S702, the CPU 110 reads out the f-value of the diaphragm 103 and sets the driving limit angle of the first correction lens 101 based on equation (4) in accordance with the f-value and the number of divided pixels, for the lens driver 112.

Next, in step S703, the CPU 110 obtains the tilt angle of the first correction lens 101 based on the output from the gyrosensor 113. In step S704, the lens driver 112 compares the tilt angle output from the CPU 110 and the driving limit angle, and if the driving limit angle is greater than the tilt angle, the processing moves to step S705, the lens driver 112 selects the driving limit angle, and the processing moves to step S707. On the other hand, if the tilt angle is less than or equal to the driving limit angle, the processing moves to step S706, the lens driver 112 selects the tilt angle from the CPU 110, and the processing moves to step S707.

In step S707, the first correction lens 101 drives the first correction lens 101 such that it reaches the angle selected in step S705 or S706, and the processing moves to step S708. In step S708, the CPU 110 checks the status of the moving image shooting SW (not shown), and if there is an instruction to stop, the image stabilization operation is ended, and if there is no instruction to stop, the processing returns to step S703, and the above-described processing is repeated.

Note that in the above-described example, a description was given in which an image stabilization operation is performed in the case of shooting a moving image, but it is also possible to execute an image stabilization operation at a time of performing a so-called live view when shooting a still image.

As described above, with this first embodiment, by controlling the drive amount when driving the image stabilization lens, it is possible to perform image stabilization in a range in which correction is possible also in the case where uneven blurring appears.

Note that only the tilt angle of the image stabilization lens was described in the first embodiment above, but there are cases where tilting occurs due to a shift lens such as the second correction lens 102 being driven, whereby uneven blurring appears. The defocus amounts for each image height that occur due to the first correction lens 101 and the second correction lens 102 being driven are included in the ROM (not shown) and are used in controlling the drive amount, thereby making it possible to control the image capturing apparatus 1 within a range in which it is possible to correct uneven blurring.

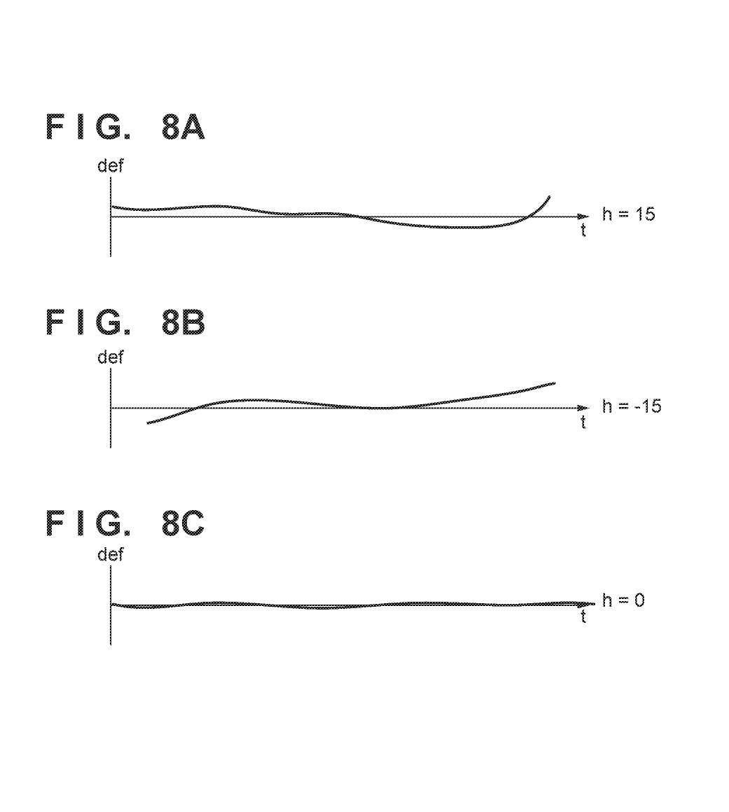

FIGS. 8A to 8C are diagrams showing examples of defocus amounts at different image heights obtained while driving the first correction lens 101 and the second correction lens 102 at a certain focus distance, the image height being indicated as h, and the defocus amount being indicated as def. FIGS. 8A to 8C show defocus amounts def in the case where the image heights h are 15, −15, and 0.

Due to the first correction lens 101 and the second correction lens 102 being driven in this way, the focus planes are different for each image height in the image sensor 104, and a state exists in which so-called uneven blurring appears, where the image is in focus at the image height center but is not in focus at other image heights. In such a case, the driving ranges of the first correction lens 101 and the second correction lens 102 are suppressed such that the defocus amounts def in the case where the image heights h are 15, −15, and 0 fall within the range expressed in equation (1), thereby making it possible to correct uneven blurring.

### Second Embodiment

Next, a second embodiment of the present invention will be described. The above-described first embodiment described a case in which charges were read out independently from 6×6 PDs by means of non-addition readout from the pixel unit cells of the image sensor 104. If the image sensor has 6×6 PDs, the charges are read out independently from the 6×6 PDs, whereby it is possible to obtain the largest range in which correction by means of refocusing is possible. However, since the amount of processing also increases proportionately, a problem occurs with regard to power consumption.

In view of this, in this second embodiment, in order to achieve a decrease in power consumption while securing the maximum amount of image stabilization of the first correction lens 101, the PD readout method is switched according to the tilt angle of the first correction lens 101. Note that the configuration of the image capturing apparatus according to the second embodiment is similar to that described with reference to FIGS. 1 and 2A to 2C in the first embodiment, and therefore description thereof will not be included here.

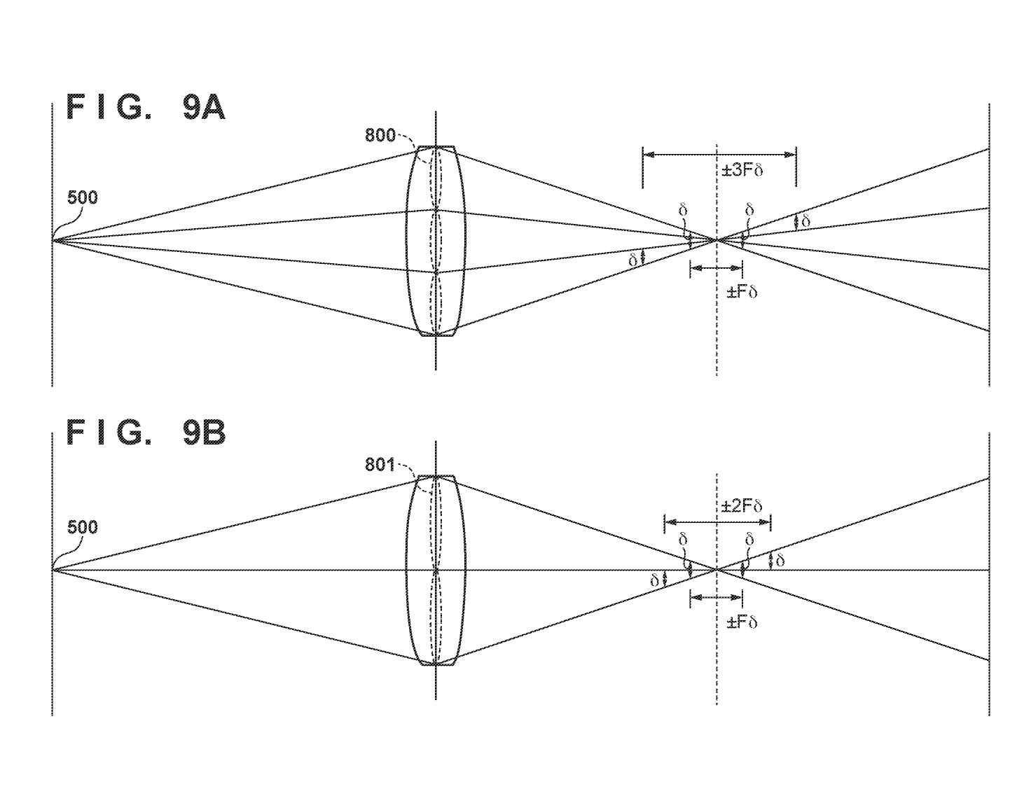

The range in which refocusing is possible at the time of changing the readout method in the second embodiment will be described with reference to FIGS. 9A and 9B. FIG. 9A shows a case of reading out 6×6 PDs by adding them together in units of 2×2 PDs. In this case, reference numeral 800 indicates a pupil portion region, the defocus amount d can be expressed by equation (5), and the focus plane can be moved virtually within the range of the defocus amount d.

|d|≦3Fδ (5)

FIG. 9B shows a case of reading out 6×6 PDs by adding them together in units of 3×3 PDs. In this case, reference numeral 801 indicates a pupil portion region, the defocus amount d can be expressed by equation (6), and the focus plane can be moved virtually within the range of the defocus amount d.

|d|≦2Fδ (6)

By switching the addition unit of addition readout according to the output from the image sensor driver 111 in this way, it is possible to change the range in which refocusing is possible. In this case, in step S701 in FIG. 7, instead of setting non-addition readout, the addition unit of addition readout is acquired, whereby the driving limit range can be obtained in step S702.

As described in the first embodiment, in the case of correcting uneven blurring that appears according to the drive amount of the first correction lens 101, the blur correction limit angle is determined according to the range in which refocusing is possible. That is to say, if the tilt angle θ1 is in the range expressed in equation (7), uneven blurring can be corrected also in the case of reading out the charges of the PDs by adding them together in units of 3×3 PDs, as described with reference to FIG. 9B.

θ1≦tan⁻¹(2Fδ/CA) (7)

Moreover, if the correction angle θ1 is in the range indicated in equation (8), uneven blurring can be corrected also in the case of reading out the charges of the PDs by adding them together in units of 2×2 pixels, as described with reference to FIG. 9A.

tan⁻¹(2Fδ/CA)<θ1≦tan⁻¹(8Fδ/CA) (8)

If the correction angle θ1 is outside of the ranges expressed in equations (7) and (8), non-addition readout, which was described with reference to FIG. 4, is performed.

Thus, by changing the PD readout method from the CPU 110 via the image sensor driver 111 in accordance with the size of the tilt angle θ1 obtained based on the output from the gyrosensor 113, it is possible to correct uneven blurring while reducing power consumption.

Moreover, similarly to the first embodiment, there are cases where defocus amounts such as those shown in FIGS. 8A to 8C appear due to the first correction lens 101 and the second correction lens 102 being driven. In such a case, correction of uneven blurring is made possible by switching addition readout based on the defocus amounts def for the image heights and the determination of the conditions of equation (7) and equation (8).

Also, in the above-described first and second embodiments, description was given under the assumption that the optical system unit 100 is included in the image capturing apparatus 1, but the optical system unit 100 may be detachable therefrom.

Also, the first and second embodiments described a configuration in which shaking of the image capturing apparatus 1 is detected by the gyrosensor 113, but the method for detecting shaking is not limited thereto, and it is possible to use a known method. For example, it is possible to use a configuration in which shaking of the image capturing apparatus 1 is detected by detecting the movement of an image between successive frames, and it is possible to use a configuration in which detection is performed using the gyrosensor 113 in combination therewith.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2015-042974, filed on Mar. 4, 2015 which is hereby incorporated by reference herein in its entirety.

What is claimed is:

1. An image capturing apparatus comprising:
an image sensor that includes a plurality of photoelectric conversion portions that correspond to each of a plurality of microlenses, and is configured to perform photoelectric conversion on a light flux that enters via an imaging optical system including an image stabilization optical system;
a refocus unit configured to perform refocus processing based on output from the image sensor; and
a determination unit configured to, based on a shake signal from a shake detection unit, determine a drive amount of the image stabilization optical system for correcting the shake, within a range in which variation in defocus amounts at positions of the image sensor, which occurs due to the image stabilization optical system being driven, falls within a range in which a defocus amount is movable by the refocus unit,
wherein the image stabilization optical system is driven based on the set drive amount.

2. The image capturing apparatus according to claim 1, wherein, based on a readout method for the plurality of photoelectric conversion portions and an aperture value of the image capture optical system, the determination unit obtains the range in which the defocus amount is movable by the refocus unit.

3. The image capturing apparatus according to claim 1, wherein the determination unit sets a limit value for the drive amount of the image stabilization optical system based on an image height of an outermost portion of the image sensor, and the range in which the defocus amount is movable by the refocus unit.

4. The image capturing apparatus according to claim 1, wherein the determination unit sets a limit value for the drive amount of the image stabilization optical system based on an image height of an outermost portion in a range in which signals are read out from the image sensor, and the range in which the defocus amount is movable by the refocus unit.

5. The image capturing apparatus according to claim 3, wherein, if the drive amount obtained based on the shake signal from the shake detection unit exceeds the limit value, the determination unit sets the limit value as the drive amount of the image stabilization optical system.

6. The image capturing apparatus according to claim 4, wherein, if the drive amount obtained based on the shake signal from the shake detection unit exceeds the limit value, the determination unit sets the limit value as the drive amount of the image stabilization optical system.

7. The image capturing apparatus according to claim 1, wherein the image stabilization optical system includes a first correction lens configured to perform image stabilization by refracting the light flux that enters.

8. The image capturing apparatus according to claim 1, wherein the image stabilization optical system includes a second correction lens configured to perform image stabilization by translating the light flux that enters.

9. The image capturing apparatus according to claim 1, further comprising
a driving unit configured to perform driving by changing a readout method for signals from the plurality of photoelectric conversion portions,
wherein the readout method includes a method of reading out from each of the plurality of photoelectric conversion portions with respect to the microlenses, and a method of reading out from the plurality of photoelectric conversion portions by dividing the plurality of photoelectric conversion portions into a plurality of regions and performing addition for each divided region.

10. The image capturing apparatus according to claim 9, wherein the driving unit changes the readout method based on the drive amount determined based on the shake signal.

11. A control method for an image capturing apparatus comprising an image sensor that includes a plurality of photoelectric conversion portions that correspond to each of a plurality of microlenses, and is configured to perform photoelectric conversion on a light flux that enters via an imaging optical system including an image stabilization optical system, and a refocus unit configured to perform refocus processing based on output from the image sensor, the control method comprising:
determining, based on a shake signal, a drive amount for the image stabilization optical system for correcting the shake, within a range in which variation in defocus amounts at positions of the image sensor, which occurs due to the image stabilization optical system being driven, falls within a range in which a defocus amount is movable by the refocus unit; and
driving the image stabilization optical system based on the determined drive amount.

12. A computer-readable storage medium storing a program for causing a computer for an image capturing apparatus, comprising an image sensor that includes a plurality of photoelectric conversion portions that correspond to each of a plurality of microlenses, and is configured to perform photoelectric conversion on a light flux that enters via an imaging optical system including an image stabilization optical system, and a refocus unit configured to perform refocus processing based on output from the image sensor, to execute the steps of the control method comprising:
determining, based on a shake signal, a drive amount for the image stabilization optical system for correcting the shake, within a range in which variation in defocus amounts at positions of the image sensor, which occurs due to the image stabilization optical system being driven, falls within a range in which a defocus amount is movable by the refocus unit; and
driving the image stabilization optical system based on the determined drive amount.
